(19) United States
(12) Patent Application Publication
(10) Pub. No.: US 2008/0110592 A1
(43) Pub. Date: May 15, 2008

(54) METHOD FOR PRODUCING 700 MPA HIGH YIELD STRENGTH WEATHERING STEEL

(75) Inventors: Xinping MAO, Guangzhou (CN); Zhenyuan LIN, Guangzhou (CN); Kexin LI, Guangzhou (CN); Jixiang GAO, Guangzhou (CN); Yijun LIU, Guangzhou (CN); Qilin CHEN, Guangzhou (CN); Jinsong XIE, Guangzhou (CN)

Correspondence Address: MATTHIAS SCHOLL, 14781 MEMORIAL DRIVE, SUITE 1319, HOUSTON, TX, 77079, US

(73) Assignee: GUANGZHOU ZHUJIANG STEEL CO., LTD., Guangzhou (CN)

(21) Appl. No.: 11/938,320

(22) Filed: Nov. 12, 2007

Related U.S. Application Data
(63) Continuation of application No. PCT/CN2006/003454, filed on Dec. 18, 2006.

(30) Foreign Application Priority Data
Nov. 10, 2006 (CN) 200610123458.1

(51) Int. Cl. B22D 11/00

(52) U.S. Cl. 164/476

(57) ABSTRACT

Taught is a method for producing 700 MPa high strength weathering steel, comprising employing a thin slab casting and rolling technology, comprising (a) smelting at a charging temperature to produce molten steel, (b) refining said molten steel at a tapping temperature, (c) thin slab continuous casting of a casting billet, (d) soaking of said casting billet, (e) hot continuous rolling of said casting billet at a finishing temperature, (f) laminar cooling of said casting billet, and (g) coiling of said casting billet at a coiling temperature, wherein C is present in the molten steel in the range of from 0.03 to 0.07 percent by weight; Si is present in the molten steel in the range of from 0.3 to 0.5 percent by weight; Mn is present in the molten steel in the range of from 0.6 to 1.6 percent by weight; P is present in the molten steel in the range of less or equal to 0.04 percent by weight; S is present in the molten steel in the range of less or equal to 0.008 percent by weight; Cu is present in the molten steel in the range of from 0.2 to 0.5 percent by weight; Cr is present in the molten steel in the range of from 0.3 to 0.7 percent by weight; Ni is present in the molten steel in the range of from 0.15 to 0.35 percent by weight; Ti is present in the molten steel in the range of from 0.08 to 0.14 percent by weight; Al is present in the molten steel in the range of from 0.025 to 0.05 percent by weight; N is present in the molten steel in the range of less or equal to 0.008 percent by weight, the charging temperature is 950-1100° C., the tapping temperature is 1100-1180° C., the finishing temperature is 870-920° C., and the coiling temperature is 550-650° C.

### CROSS-REFERENCE TO RELATED APPLICATIONS

This application is a continuation of International Patent Application No. PCT/CN2006/00003454, with an international filing date of Dec. 18, 2006, which is based on Chinese Patent Application No. 200610123458.1, filed Nov. 10, 2006. The contents of these specifications are incorporated herein by reference.

### BACKGROUND OF THE INVENTION

1. Field of the Invention

The invention relates to high strength steel, and more particularly to a method for producing 700 MPa high strength weathering steel.

2. Description of the Related Art

Nowadays, high strength weathering steels are widely used in transportation and manufacturing. A 700 MPa high strength weathering steel is one of the strongest available.

However, the conventional production process of the 700 MPa high strength weathering steel employs composite microalloy technology, which has complex control procedures, low product rate, and high cost.

Tables 1 and 2 illustrate elemental composition of conventional 700 MPa high yield strength weathering steels by representative steel makers (wt %).

TABLE 1

| Steel | | C | Si | Mn | P | S | Cu | Ni |
|---|---|---|---|---|---|---|---|---|
| maker | Brand | x102 | x102 | x102 | x103 | x103 | x102 | x102 |
| SSAB, Sweden | Domex700w | 6.4 | 37 | 103 | 12 | 2 | 32 | 18.1 |
| America | HSLA-100 | 2 | 25 | 87 | 3 | 6 | 198 | 35.4 |
| Japan | CIMC-700 | 5 | 8 | 133 | 8 | 4 | 24 | 80 |
| Zhuzhou Steel, China | ZJ700N | 5 | 35 | 141 | 82 | 4 | 25 | 18.5 |
| Zhuzhou Steel, China | ZJ700N | 5.5 | 35 | 110 | 15 | 3 | 26 | 18.2 |

TABLE 2

| Steel | | Cr | Al | Nb | V | Ti | Mo | N |
|---|---|---|---|---|---|---|---|---|
| maker | Brand | x102 | x103 | x103 | x103 | x103 | x103 | x106 |
| SSAB, Sweden | Domex700w | 65.2 | 55.3 | 51.2 | 14 | 113 | 21 | — |
| America | HSLA-100 | 58 | 38 | 32 | — | — | 56 | — |
| Japan | CIMC-700 | 40 | 40.5 | 34.6 | 12 | 98 | 26 | — |
| Zhuzhou Steel, China | ZJ700N | 41.3 | 40 | 0 | 149 | 0 | 0 | 220 |
| Zhuzhou Steel, China | ZJ700N | 42 | 35.6 | 0 | 0 | 109 | 0 | 70 |

### SUMMARY OF THE INVENTION

In view of the above-described problems, it is one objective of the invention to provide a method for producing high strength weathering steel that features simple control procedures, high product rate, and low cost.

To achieve the above objectives, in accordance with one embodiment of the invention, provided is a method for producing 700 MPa high strength weathering steel, comprising employing a thin slab casting and rolling technology, said technology comprising smelting, refining, thin slab continuous casting, soaking, hot continuous rolling, laminar cooling and coiling; wherein the chemical composition of the molten steel are: C is present in the range of from 0.03 to 0.07 percent by weight; Si is present in the range of from 0.3 to 0.5 percent by weight; Mn is present in the range of from 0.6 to 1.6 percent by weight; P is present in the range of less or equal to 0.04 percent by weight; S is present in the range of less or equal to 0.008 percent by weight; Cu is present in the range of from 0.2 to 0.5 percent by weight; Cr is present in the range of from 0.3 to 0.7 percent by weight; Ni is present in the range of from 0.15 to 0.35 percent by weight; Ti is present in the range of from 0.08 to 0.14 percent by weight; Al is present in the range of from 0.025 to 0.05 percent by weight; and N is present in the range of less or equal to 0.008 percent by weight; the charging temperature of the casting billet is 950-1100° C., the tapping temperature thereof is 1100-1180° C., the finishing temperature thereof is 870-920° C., and the coiling temperature thereof is 550-650° C.

In certain classes of this embodiment, C is present in the range of from 0.055 to 0.065 percent by weight.

In certain classes of this embodiment, Mn is present in the range of from 1.2 to 1.5 percent by weight.

In certain classes of this embodiment, P is present in the range of from 0.01 to 0.02 percent by weight.

In certain classes of this embodiment, Ni is present in the range of from 0.09 to 0.11 percent by weight.

In certain classes of this embodiment, S is present in the range of less or equal to 0.003 percent by weight.

In certain classes of this embodiment, the charging temperature of a casting billet is 950-1050° C.

In certain classes of this embodiment, the tapping temperature of a casting billet is 1110-1160° C.

In certain classes of this embodiment, the finishing temperature of a casting billet is 880-910° C.

In certain classes of this embodiment, the coiling temperature of a casting billet is 580-620° C.

Advantages of the invention include:
1) By restricting elements such as S, N, and so on to a certain range, namely S≦0.008 wt. % and N≦0.007 wt. %, the chemical reaction between Ti and these elements is controlled, and thus yield strength of the steel is larger than 700 MPa.
2) By using a thin slab casting and rolling technology, fluctuation in the performance of Ti microalloy steels is controlled, in detail, fluctuation in yield strength and tensile strength is within 30 MPa.

### DETAILED DESCRIPTION OF THE INVENTION

In a first embodiment, the method for producing 700 MPa high strength weathering steel comprises: (a) smelting in a 150 t ultra-high power electric furnace, (b) refining in a 150 t ladle furnace, (c) continuous casting into a 60 mm thin slab, (d) soaking, (e) descaling using high pressure water, (f) hot continuous rolling through 6 stands, (g) laminar cooling, and (h) coiling.

The steel comprises the following chemical elements by weight: C is present in the range of from 0.041 to 0.053 percent by weight; Si is present in the range of from 0.32 to 0.39 percent by weight; Mn is present in the range of from 1.34 to 1.43 percent by weight; P is present in the range of less or equal to 0.037 percent by weight; S is present in the range of less or equal to 0.007 percent by weight; Cu is present in the range of from 0.28 to 0.32 percent by weight; Cr is present in the range of from 0.39 to 0.424 percent by weight; Ni is present in the range of from 0.189 to 0.205 percent by weight; Ti is present in the range of from 0.083 to 0.094 percent by weight; Al is present in the range of from 0.0305 to 0.0402 percent by weight; and N is present in the range of less or equal to 0.0067 percent by weight.

The process parameters are as follows: the charging temperature of the casting billet is 957-992° C., the tapping temperature thereof is 1107-1124° C., the finishing temperature thereof is 872-895° C., and the coiling temperature thereof is 563-589° C.

Mechanical properties of a steel sheet according to the first embodiment are shown in Table 3.

TABLE 3

| | | | | Wide cold |
|---|---|---|---|---|
| Thickness of | | | | bending |
| steel sheet | Rel | Rm | A₅ | B = 35 mm, d = a, |
| (mm) | (Mpa) | (Mpa) | (Mpa) | 180° |
| 6 | 705 | 780 | 26 | Qualified |
| 5 | 705 | 785 | 25 | Qualified |
| 4 | 710 | 790 | 25 | Qualified |
| 3.5 | 715 | 795 | 25 | Qualified |
| 3.2 | 725 | 810 | 25 | Qualified |
| 3 | 725 | 815 | 24 | Qualified |
| 2.5 | 730 | 825 | 22 | Qualified |

In a second embodiment, a method for producing 700 MPa high strength weathering steel comprises: (a) smelting in a 150 t ultra-high power electric furnace, (b) refining in a 150 t ladle furnace, (c) continuous casting into a 58 mm thin slab, (d) soaking, (e) descaling using high pressure water, (f) hot continuous rolling through 6 stands, (g) laminar cooling, and (h) coiling.

The steel comprises the following chemical elements by weight: C is present in the range of from 0.052 to 0.061 percent by weight; Si is present in the range of from 0.35 to 0.41 percent by weight; Mn is present in the range of from 1.41 to 1.51 percent by weight; P is present in the range of less or equal to 0.029 percent by weight; S is present in the range of less or equal to 0.006 percent by weight; Cu is present in the range of from 0.25 to 0.28 percent by weight; Cr is present in the range of from 0.407 to 0.425 percent by weight; Ni is present in the range of from 0.184 to 0.19 percent by weight; Ti is present in the range of from 0.091 to 0.103 percent by weight; Al is present in the range of from 0.023 to 0.04 percent by weight; and N is present in the range of less or equal to 0.0061 percent by weight.

The process parameters are as follows: the charging temperature of the casting billet is 979-1013° C., the tapping temperature thereof is 1131-1156° C., the finishing temperature thereof is 881-907° C., and the coiling temperature thereof is 587-615° C.

Mechanical properties of a steel sheet according to the second embodiment are shown in Table 4.

TABLE 4

| | | | | Wide cold |
|---|---|---|---|---|
| Thickness of | | | | bending |
| steel sheet | Rel | Rm | A₅ | B = 35 mm, d = a, |
| (mm) | (Mpa) | (Mpa) | (Mpa) | 180° |
| 6 | 705 | 775 | 27 | Qualified |
| 5 | 705 | 780 | 26 | Qualified |
| 4 | 710 | 790 | 26 | Qualified |
| 3.5 | 715 | 800 | 25 | Qualified |
| 3.2 | 725 | 805 | 26 | Qualified |
| 3 | 725 | 805 | 25 | Qualified |
| 2.5 | 730 | 810 | 25 | Qualified |

In a third embodiment, a method for producing 700 MPa high strength weathering steels comprises: (a) smelting in a 150 t ultra-high electric furnace, (b) refining in a 150 t ladle furnace, (c) continuous casting into a 56 mm thin slab, (d) soaking, (e) descaling using high pressure water, (f) hot continuous rolling through 6 stands, (g) laminar cooling, and (h) coiling.

The steel comprises the following chemical elements by weight: C is present in the range of from 0.059 to 0.068 percent by weight; Si is present in the range of from 0.37 to 0.4 percent by weight; Mn is present in the range of from 1.02 to 1.1 percent by weight; P is present in the range of less or equal to 0.034 percent by weight; S is present in the range of less or equal to 0.002 percent by weight; Cu is present in the range of from 0.26 to 0.27 percent by weight; Cr is present in the range of from 0.557 to 0.585 percent by weight; Ni is present in the range of from 0.197 to 0.202 percent by weight; Ti is present in the range of from 0.102 to 0.127 percent by weight; Al is present in the range of from 0.029 to 0.037 percent by weight; and N is present in the range of less or equal to 0.0056 percent by weight.

The process parameters are as follows: the charging temperature of a casting billet is 994-1037° C., the tapping temperature thereof is 1142-1166° C., the finishing temperature thereof is 892-916° C., and the coiling temperature thereof is 604-627° C.

Mechanical properties of a steel sheet according to the third embodiment are shown in Table 5.

TABLE 5

| | | | | Wide cold |
|---|---|---|---|---|
| Thickness of | | | | bending |
| steel sheet | Rel | Rm | A₅ | B = 35 mm, d = a, |
| (mm) | (Mpa) | (Mpa) | (Mpa) | 180° |
| 6 | 705 | 805 | 23 | Qualified |
| 5 | 710 | 810 | 22 | Qualified |
| 4 | 715 | 810 | 22 | Qualified |
| 3.5 | 715 | 810 | 22 | Qualified |
| 3.2 | 725 | 810 | 22 | Qualified |
| 3 | 735 | 820 | 21 | Qualified |
| 2.5 | 745 | 835 | 21 | Qualified |

While particular embodiments of the invention have been shown and described, it will be obvious to those skilled in the art that changes and modifications may be made without departing from the invention in its broader aspects, and therefore, the aim of the appended claims is to cover all such changes and modifications as fall within the true spirit and scope of the invention.

What is claimed is:

1. A method for producing high yield strength weathering steel comprising:
(a) smelting at a charging temperature to produce molten steel,
(b) refining said molten steel at a tapping temperature,
(c) thin slab continuous casting of a casting billet,
(d) soaking of said casting billet,
(e) hot continuous rolling of said casting billet at a finishing temperature,
(f) laminar cooling of said casting billet, and
(g) coiling of said casting billet at a coiling temperature,
wherein
C is present in the molten steel in the range of from 0.03 to 0.07 percent by weight;
Si is present in the molten steel in the range of from 0.3 to 0.5 percent by weight;
Mn is present in the molten steel in the range of from 0.6 to 1.6 percent by weight;
P is present in the molten steel in the range of less or equal to 0.04 percent by weight;
S is present in the molten steel in the range of less or equal to 0.008 percent by weight;
Cu is present in the molten steel in the range of from 0.2 to 0.5 percent by weight;
Cr is present in the molten steel in the range of from 0.3 to 0.7 percent by weight;
Ni is present in the molten steel in the range of from 0.15 to 0.35 percent by weight;
Ti is present in the molten steel in the range of from 0.08 to 0.14 percent by weight;
Al is present in the molten steel in the range of from 0.025 to 0.05 percent by weight;
N is present in the molten steel in the range of less or equal to 0.008 percent by weight;
the charging temperature is 950-1100° C.,
the tapping temperature is 1100-1180° C.,
the finishing temperature is 870-920° C., and
the coiling temperature is 550-650° C.

2. The method of claim 1, wherein C is present in the molten steel in the range of from 0.055 to 0.065 percent by weight.

3. The method of claim 1, wherein Mn is present in the molten steel in the range of from 1.2 to 1.5 percent by weight.

4. The method of claim 1, wherein P is present in the molten steel in the range of from 0.01 to 0.02 percent by weight.

5. The method of claim 1, wherein Ni is present in the molten steel in the range of from 0.09 to 0.11 percent by weight.

6. The method of claim 1, wherein S is present in the molten steel in the range of less or equal to 0.003 percent by weight.

7. The method of claim 1, wherein the charging temperature is between 950 and 1050° C.

8. The method of claim 1, wherein the tapping temperature is between 1110 and 1160° C.

9. The method of claim 1, wherein the finishing temperature is between 880 and 910° C.

10. The method of claim 1, wherein the coiling temperature is between 580 and 620° C.

11. The method of claim 1, wherein the yield strength of the steel is over 700 MPa.
